(19) United States
(12) Patent Application Publication
(10) Pub. No.: US 2006/0079299 A1
(43) Pub. Date: Apr. 13, 2006

(54) Sliding structure for a mobile device

(75) Inventors: Wei-Cheng Chen, Gueishan Township (TW); Luen-Chiu Lin, Gueishan Township (TW); Shu-Lien Wu, Gueishan Township (TW)

Correspondence Address: TROXELL LAW OFFICE PLLC;SUITE 1404, 5205 LEESBURG PIKE, FALLS CHURCH, VA, 22041, US

(73) Assignee: Speed Tech Corp.

(21) Appl. No.: 10/984,768

(22) Filed: Nov. 10, 2004

(30) Foreign Application Priority Data
Oct. 7, 2004 (TW) 093215886

(51) Int. Cl. H04Q 7/32

(52) U.S. Cl. 455/575.1; 455/550.1

(57) ABSTRACT

The present invention is a sliding structure for a mobile device, which has a main body and a sub body buckled with each other for sliding within a predestined distance, having a cover and a base disposed on the main body and sub body respectively; and at least one elastic member having two ends disposed at the cover and the base respectively, where the extension line traveling through the two ends of the elastomer is never parallel to the sliding directions of the cover or the base so that the cover and the base can relatively sliding over each other within a certain predestined distance.

### FIELD OF THE INVENTION

The present invention relates to a sliding structure; more particularly, relates to a sliding structure driving the handset to the predestined positions.

### DESCRIPTION OF THE PRIOR ART

Please refer to FIG. 8. A mobile handset with a sliding structure disclosed in US Patent Publication No. 2004/0085739 A1 comprises a main body 101, a sub body 102 and a spring module 150. Therein, the spring module 150 comprises a front cover 151, a rear cover 153 and torsion springs 155 disposed between the front cover 151 and the rear cover 153. And a pair of sliding guides 127 is disposed on the sub body 102 for the rear cover 153 of the spring module 150 to slide along so that the sub body 102 can be slid to the opening position or the closing position on the main body 101 by the spring module 150 and the sub body 102 can move along the sliding guides 127.

Although, by the above structure, the main body 101 and the sub body 102 can be pushed or pulled by the spring module 150 and the sub body 102 can move along the sliding guides 127, the spring module 150 is not reliable for the torsion springs 155 of the spring module 150 to efficiently restore the energy stored from a deformation. An end user has to further push or pull the main body 101 or the sub body 102 to the predestined positions. So, the prior art is not convenient and has to be redesigned.

### SUMMARY OF THE INVENTION

Therefore, the first object of the present invention is to disclose a sliding structure combined into a mobile device, having a main body and a sub body capable of traveling a certain distance between predestined positions by sliding on each other.

Another object of the invention is to disclose a sliding structure for a mobile device, which is capable of pushing the main body or the sub body to the predestined positions automatically.

To achieve the above objects, the present invention comprises a cover, a base and at least an elastic member. The cover and the base are respectively fixed on the main body and the sub body of the mobile device and are buckled with each other by buckles so that they are capable of traveling over each other within a certain distance. The elastic member of the present invention is a bendable elastomer, whose both ends are respectively disposed on the cover and the base. And, a line extending through the two ends of the elastic member is never parallel to the sliding directions of the cover and the base. Accordingly, the main body and the sub body are capable of sliding to predestined positions automatically and reliably.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is a perspective view according to a first preferred embodiment of the present invention;

FIG. 2 is an explosive view according to the first preferred embodiment of the present invention;

FIG. 3 is a view showing a status of use on assembling according to the first preferred embodiment of the present invention;

FIG. 4A and FIG. 4B are views showing a cover closed at a predestined position according the first preferred embodiment of the present invention;

FIG. 5A and FIG. 5B are views showing the cover moved to a position where an elastic member is squeezed most according to the first preferred embodiment of the present invention;

FIG. 6A and FIG. 6B are views showing the cover opened to another predestined position according to the first preferred embodiment of the present invention;

FIG. 7 is a perspective view according to a second preferred embodiment of the present invention; and

FIG. 8 is an explosive view according to a prior art.

### DESCRIPTION OF THE PREFERRED EMBODIMENTS

The following descriptions of the preferred embodiments are provided to understand the features and the structures of the present invention.

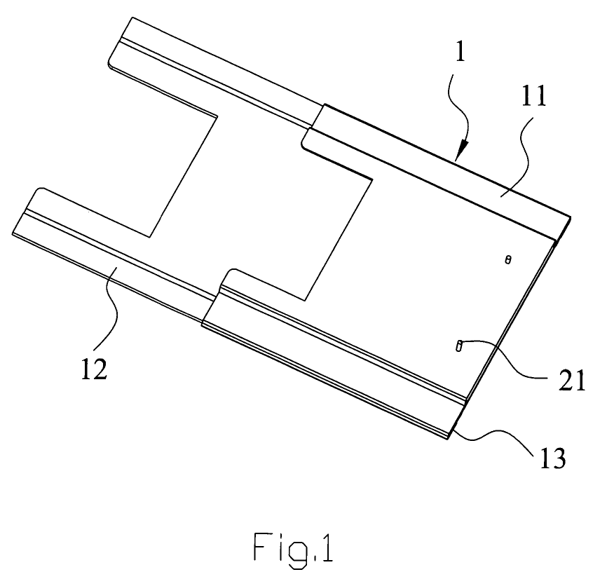

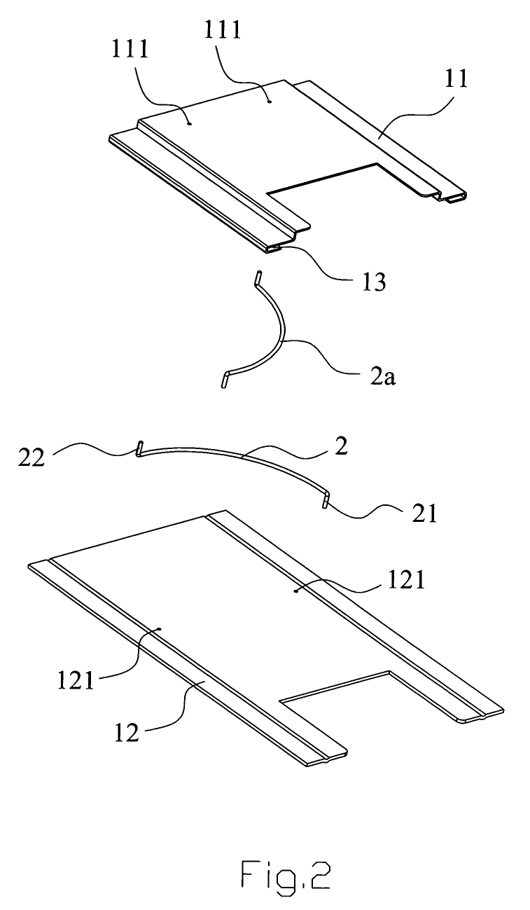

Please refer to FIG. 1 and FIG. 2. As shown in the figures, the first preferred embodiment according to the present invention is a sliding structure for a mobile device. The sliding structure 1 comprises a cover 11, a base 12, and two elastic members 2,2a, which is integrated into the mobile device so that a main body and a sub body of the mobile device is capable of traveling over each other within a certain distance. In this first preferred embodiment, there are two elastic members 2,2a, but one skilled in the art can use only one elastic member to practice and that should be treated as an equivalent embodiment to the first preferred embodiment of the present invention.

In the first preferred embodiment, the cover 11 and the base 12 are relatively slidable and are joined together. Sliding guides 13 are formed at two lateral sides of the cover 11 respectively for two lateral sides of the base 12 to slide on. There are fixing holes 111,121 deployed at the cover 11 and the base 12 respectively for holding the elastic members 2,2a. According to the above descriptions where the actions and the structures of the two elastic members 2,2a are the same, only one elastic member 2 will be taken as an example in the following descriptions.

In the first preferred embodiment, the elastic member 2 is a bendable elastomer, capable of storing the energy through a torsion and restoring to generate the sliding to push the cover 11 or base 12 to the predestined positions. The elastic member 2 comprises two ends 21,22 each fixed into a fixing hole 111,121 of the cover 11 or the base 12 respectively. Since the cover 11 and the base 12 slide over each other and the elastic member 2 is fixed between the cover 11 and the base 12 by the two ends 2,2a, after assembly, the line extending through the two ends 2,2a of the elastic member 2 will never parallel to the sliding directions of the cover 11 and the base 12 to prevent the elastic member 2 from bending toward an uncertain direction.

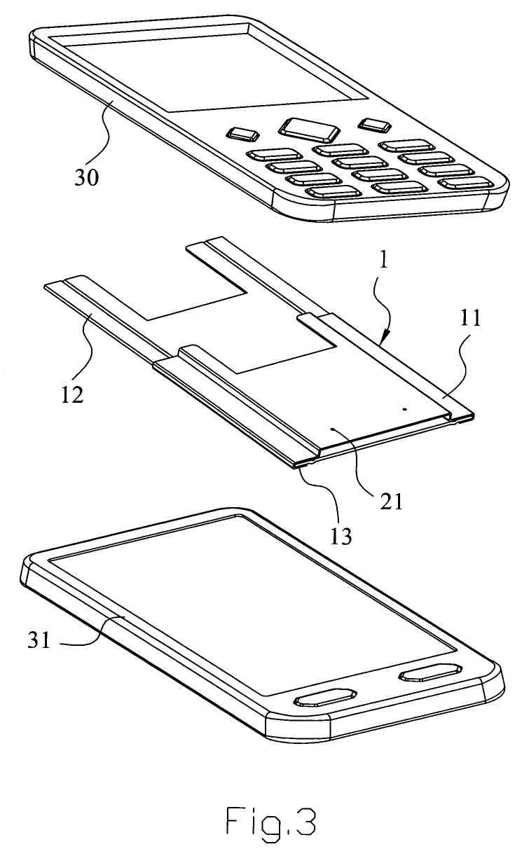

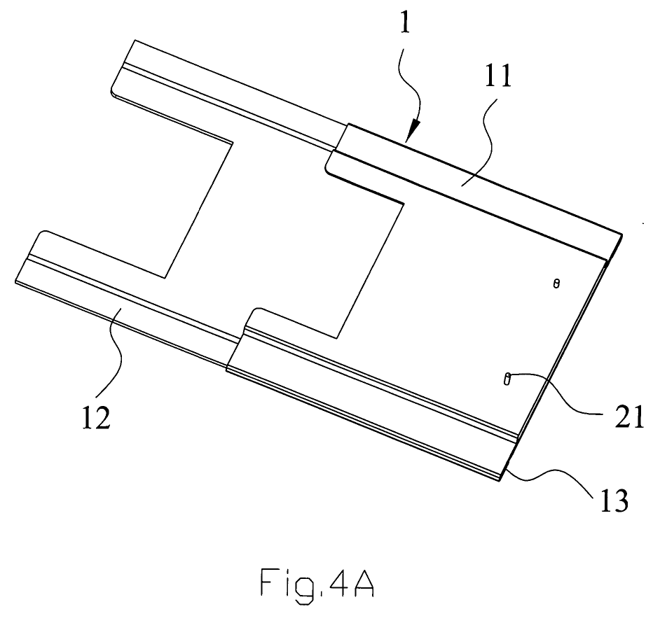

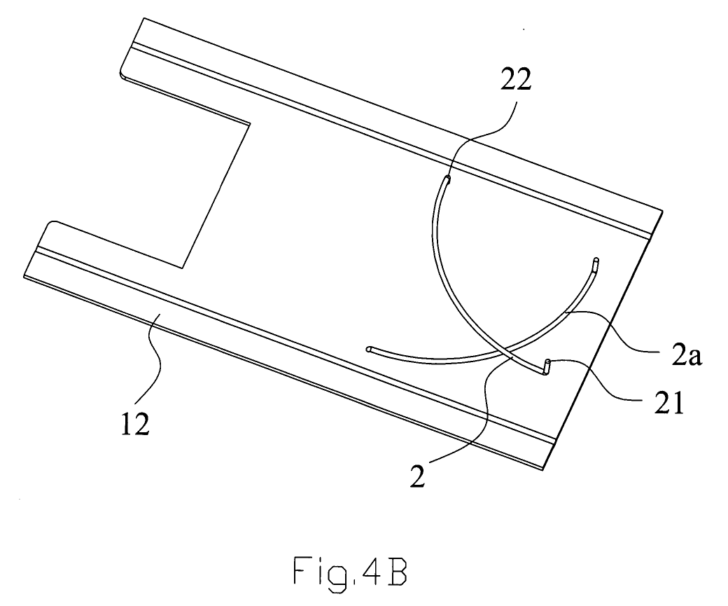

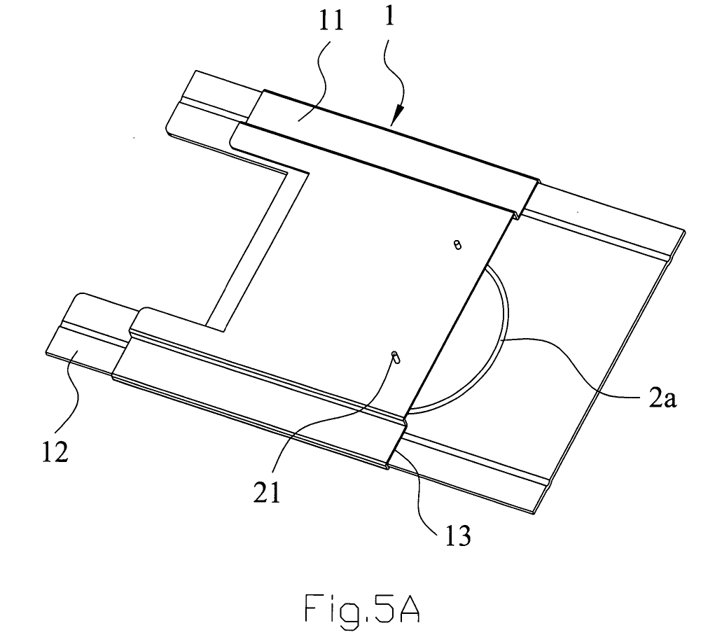

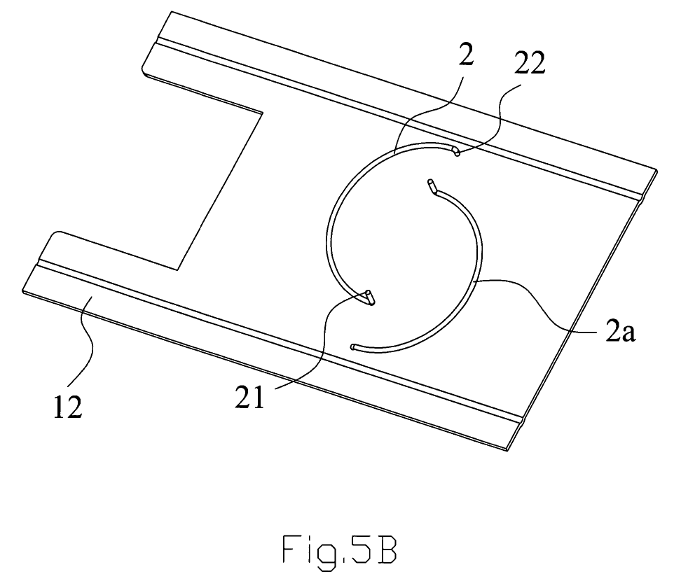

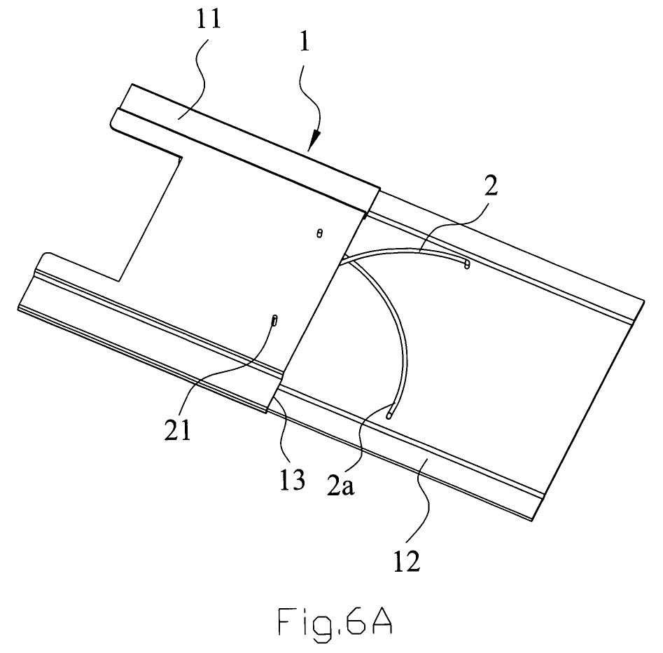

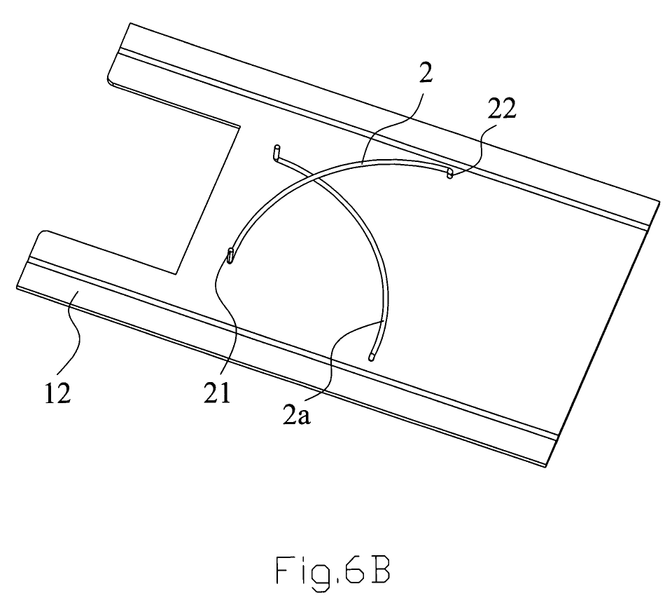

Please refer to FIG. 3 through FIG. 6B. On assembling the first preferred embodiment according to the present invention, the cover 11 of the sliding structure 1 is disposed on the main body 30 of the mobile device; and the base 12 on the sub body 31 (as show in FIG. 3). When a user pushes the main body 30 toward a particular direction, the cover 11 is carried by the main body 30 to slide.

One end of the elastic member 2 is positioned at the cover 11 and the other end is at the base 12. Therefore, the elastic member 2 starts to store energy when the cover 11 starts sliding by force.

When the cover 11 is moved to pass through a critical position, a line extending through the two ends 21,22 of the elastic member 2 is perpendicular to the sliding direction of the cover 11, and the energy stored in the elastic member 2 restores. Once the cover 11 surpasses the critical position, the energy restored from the elastic member 2 pushes the cover 11 to keep sliding toward a predestined position. Even when the force pushing the cover 11 is removed, the cover 11 will still keep sliding by the energy restored from the elastic member 2. Therefore, the main body 30 and the sub body 31 are capable of sliding to predestined positions automatically.

In this embodiment, the elastic member 2 is capable of being elastically deformed from a free status, and one skilled in the art can make a simple modification which makes the elastic member 2 capable of storing more sufficient energy, such as, but not limited to, replacing the elastic member 2 with a material having more elasticity or a sheet metal folded times.

According to what is disclosed above, for ensuring the reliability of keeping the main body 30 and the sub body 31 at the predestined positions precisely, a pre-load applied to the main body 30 and the sub body 31 by the elastic member 2 is considerable. If the main body 30 is at the opening predestined position and the elastic member 2 keeps pushing the cover 11 away from the base 12, the main body 30 is forced to remain at the opening predestined position. It is obvious that, to slide the main body 30 to the closing predestined position while overcoming the pre-load, one needs to push the main body 30 harder than a non-pre-load design. Owing to the design of the buckles between the cover 11 and the base 12, the related positions of the main body 30 and the sub body 31 are limited to prevent from departing each other. In this way, the main body 30 and the sub body 31 can be kept in the positions between opening and closing predestined positions.

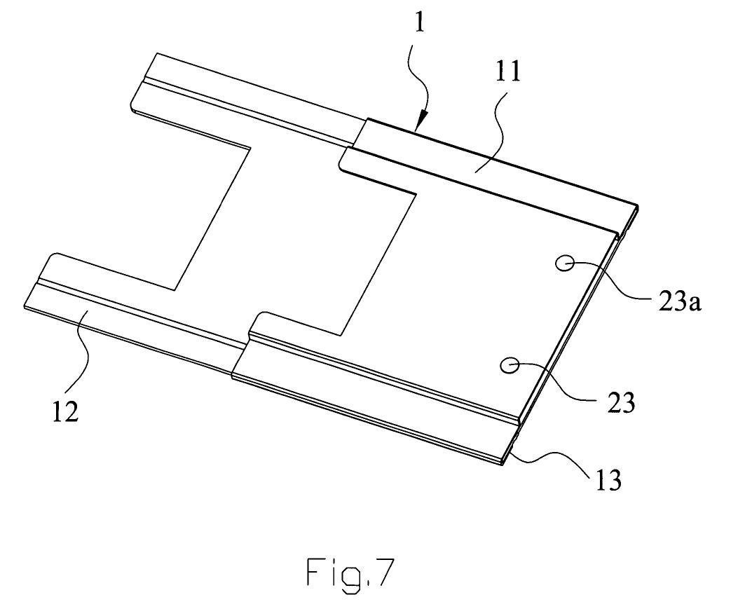

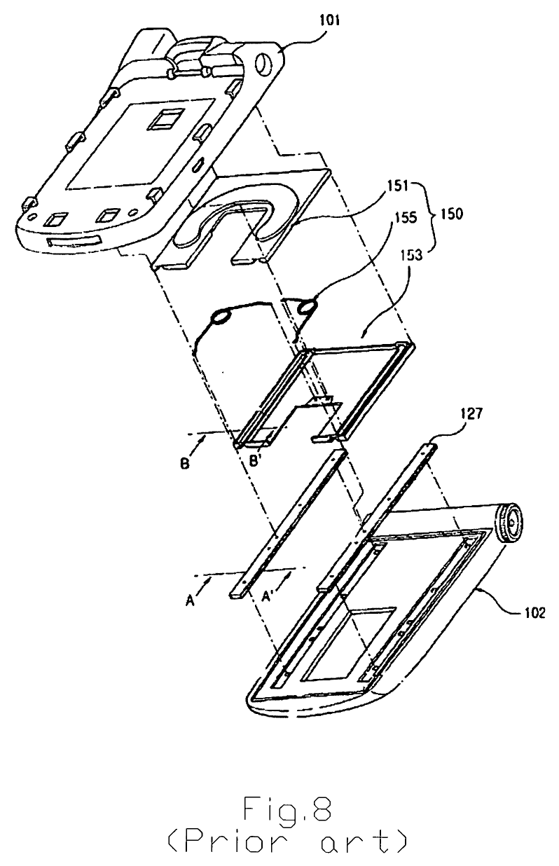

Please refer to FIG. 7, which is a second preferred embodiment according to the present invention. As shown in the figure, one of both ends of an elastic member 2 is capable of being riveted to the cover 11 by a riveting member 23, and the elastic member 2 is capable of storing energy by deforming the elastic member 2 as mentioned above.

The preferred embodiments herein disclosed are not intended to unnecessarily limit the invention. Therefore, simple modifications or variations to the cover and the base concerning the design of sliding guides and buckles and/or to the elastic member concerning the design of a fixing method, that are belonging to the equivalent of the scope of the claims and the instructions disclosed herein for a patent, are all within the scope of the present invention.

What is claimed is:

1. A sliding structure for a mobile device, having a main body and a sub body buckled with each other to be slid on each other within a predestined distance, comprising:
a cover, a base and an elastic member having two ends disposed at said cover and base respectively,
wherein said cover and said base are disposed on said main body and said sub body of the mobile device respectively,
characterized in that an extension line traveling through two ends of said elastic member is never parallel to the sliding directions of said cover and said base.

2. The sliding structure according to claim 1, wherein at least two said elastic members are disposed between said cover and said base.

3. The sliding structure according to claim 1, wherein said elastic member comprises two ends and each of said two ends is riveted on the cover by a riveting member.
